(19) United States
(12) Patent Application Publication
(10) Pub. No.: US 2017/0086261 A1
(43) Pub. Date: Mar. 23, 2017

(54) MICROWAVE HEATING DEVICE AND DRAWER DOOR ASSEMBLY USED FOR THE SAME

(71) Applicants: GUANGDONG MIDEA KITCHEN APPLIANCES MANUFACTURING CO., LTD., Foshan (CN); MIDEA GROUP CO., LTD., Foshan (CN)

(72) Inventor: Jianyi ZHOU, Foshan (CN)

(21) Appl. No.: 14/865,026

(22) Filed: Sep. 25, 2015

(30) Foreign Application Priority Data
Sep. 21, 2015 (CN) 201520731403.3

(51) Int. Cl. H05B 6/64

(52) U.S. Cl. CPC H05B 6/6414; H05B 6/6402

(57) ABSTRACT

The present invention disclose a microwave heating device and a drawer door assembly used for the same, the microwave heating device includes: an oven body defining a microwave heating chamber therein; a drawer door having a door panel and movably installed on the oven body so as to enable the door panel to open and close the microwave heating chamber; a control box having a control panel and installed at the top of the door panel, and the control panel being facing upward. The microwave heating device according to the present invention enables user, especially those who cannot easily bend over or stoop, like elderly people, to manipulate the control panel conveniently, thus improving the use of convenience, and improving the aesthetics of the microwave heating device at the same time.

### CROSS-REFERENCE TO RELATED APPLICATION

The present application claims the benefit of and priority to Chinese Application No. 201520731403.3 filed Sep. 21, 2015, the entire disclosure of which is incorporated herein by reference.

### FIELD

The present invention relates to a field of household appliances, and more particularly to a microwave heating device and a drawer door assembly used for the microwave heating device.

### BACKGROUND

When operating and using a drawer type microwave heating device embedded in a wall or cabinet in related art, user need to bend over or stoop, thus causing some inconvenience for those who cannot easily bend over, especially for elderly people, and the drawer type microwave heating device matches up the whole cabinet with a poor overall coordination and not beauty enough.

### SUMMARY

The present invention seeks to solve at least one of the problems existing in the related art to at least some extent, for this, the present invention provides a microwave heating device with advantages of easy operation and overall aesthetic appearance.

The present invention further provides a drawer door assembly used for the microwave heating device, which can be conveniently used and can improve the appearance.

A microwave heating device according to the present invention includes: an oven body defining a microwave heating chamber therein; a drawer door provided with a door panel and movably installed on the oven body so as to enable the door panel to open and close the microwave heating chamber; a control box having a control panel and installed at the top of the door panel, and the control panel being facing upward.

With the microwave heating device according to the present invention, user need not to bend over or stoop to operate, thereby it is convenient to control the panel for user, especially for elderly people, thus improving the use of convenience and the aesthetics of the microwave heating device.

In some embodiments of the present invention, the door panel defines an installing chamber therein and an operating port communicating with the installing chamber at an upper surface thereof, the control box is installed inside the installing chamber, and the control panel is exposed from the operating port.

Optionally, an upper surface of the control panel is flush with the upper surface of the door panel.

Optionally, the control panel is positioned at the central of the upper surface of the door panel in a right-left direction, and is adjacent to a front surface of the door panel in a front-rear direction.

In some embodiments of the present invention, the door panel covers a whole front surface of the oven body when closing the microwave heating chamber.

Optionally, the door panel has a larger size at a rear surface in an up-down direction than a size at the front surface of the oven body in the up-down direction, and the door panel has a larger size at the rear surface in an left-right direction than a size at the front surface of the oven body in the left-right direction.

In some embodiments of the present invention, the oven body is provided with a decorative piece, the control panel is shielded by the decorative piece when the door panel closes the microwave heating chamber, and the control panel avoids the decorative piece and is exposed when the door panel opens the microwave heating chamber.

Optionally, the decorative piece is provided at the front surface of the oven body and extends in the left-right direction; the door panel with the decorative piece covers the whole front surface of the oven body when the door panel closes the microwave heating chamber.

Further, when the door panel closes the microwave heating chamber, a left side surface of the door panel is flush with a left side surface of the decorative piece, and a right side surface of the door panel is flush with a right side surface of the decorative piece.

Further, both the decorative piece and the door panel have larger sizes at the rear surfaces in the left-right direction than the size at the front surface of the oven body in the left-right direction, a sum of sizes at the rear surfaces of the decorative piece and the door panel in the up-down direction adding a gap between the decorative piece and the door panel is larger than the size at the front surface of the oven body in the up-down direction.

In some embodiments of the present invention, the door panel is provided with a window for observing a situation inside the microwave heating chamber.

In some embodiments of the present invention, the door panel is provided with a door handle for pushing and pulling the drawer door.

In addition, the present invention further provides a drawer door assembly used for the microwave heating device.

The drawer door assembly used for the microwave heating device according to the present invention includes: a drawer; a door panel installed on the drawer; a control box having a control panel and installed at the top of the door panel, and the control panel being facing upward.

With the drawer door assembly used for the microwave heating device according to the present invention, users do not need to bend over or stoop to operate, thereby it is convenient to use for elderly people, thus improving the use of convenience and the overall appearance.

### BRIEF DESCRIPTION OF THE DRAWINGS

FIG. 1 is a schematic diagram of a microwave heating device when the drawer door is closed according to an embodiment of the present invention;

FIG. 2 is a schematic diagram of a microwave heating device when the drawer door is open according to an embodiment of the present invention;

FIG. 3 is schematic diagram of a microwave heating device when the drawer door is closed according to another embodiment of the present invention;

FIG. 4 is a schematic diagram of a microwave heating device when the drawer door is open according to another embodiment of the present invention;

FIG. 5 is a schematic diagram showing a side structure of a microwave heating device according to another embodiment of the present invention.

### REFERENCE NUMERALS

100: microwave heating device; 1: oven body, 11: microwave heating chamber, 12: driving device, 121: push rod device, 122: electric motor, 13: interlocking bracket, 14: guide rail, 2: drawer door, 21: door panel, 22: drawer, 23: push rod, 24: guide rail connecting plate, 25: hook; 3: control panel; 4: door handle; 5: windows; 6: decorative pieces.

### DETAILED DESCRIPTION

Reference will be made in detail to embodiments of the present invention. The embodiments described herein with reference to drawings are explanatory, illustrative, and used to generally understand the present invention. The embodiments shall not be construed to limit the present invention. The same or similar elements and the elements having same or similar functions are denoted by like reference numerals throughout the descriptions.

In the specification, it is to be understood that terms such as “central,” “longitudinal,” “lateral,” “length,” “width,” “thickness,” “upper,” “lower,” “front,” “rear,” “left,” “right,” “vertical,” “horizontal,” “top,” “bottom,” “inner,” “outer,” “clockwise,” and “counterclockwise” should be construed to refer to the orientation as then described or as shown in the drawings under discussion. These relative terms are for convenience of description and do not require that the present invention be constructed or operated in a particular orientation.

In addition, terms such as “first” and “second” are used herein for purposes of description and are not intended to indicate or imply relative importance or significance or to imply the number of indicated technical features. Thus, the feature defined with “first” and “second” may comprise one or more of this feature. In the description of the present invention, “a plurality of” means two or more than two, unless specified otherwise.

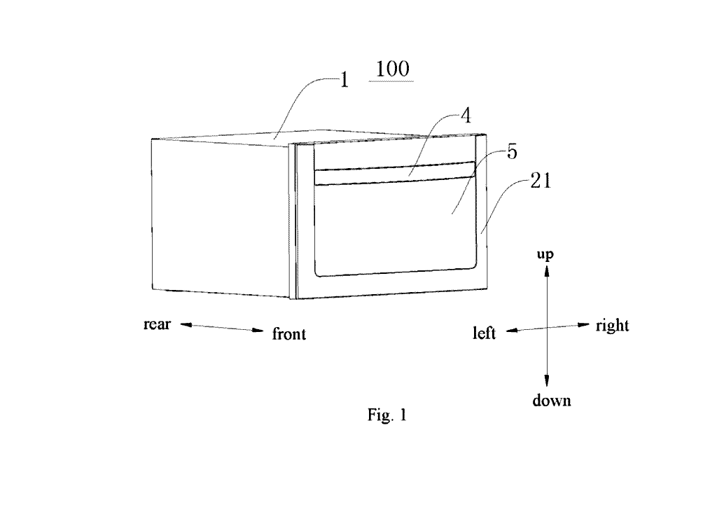

In the following, the microwave heating device 100 according to embodiments of the present invention will be described with referring to FIG. 1 to FIG. 5. In specific, the microwave heating device 100 can be a microwave oven or roaster embedded in a wall or cabinet.

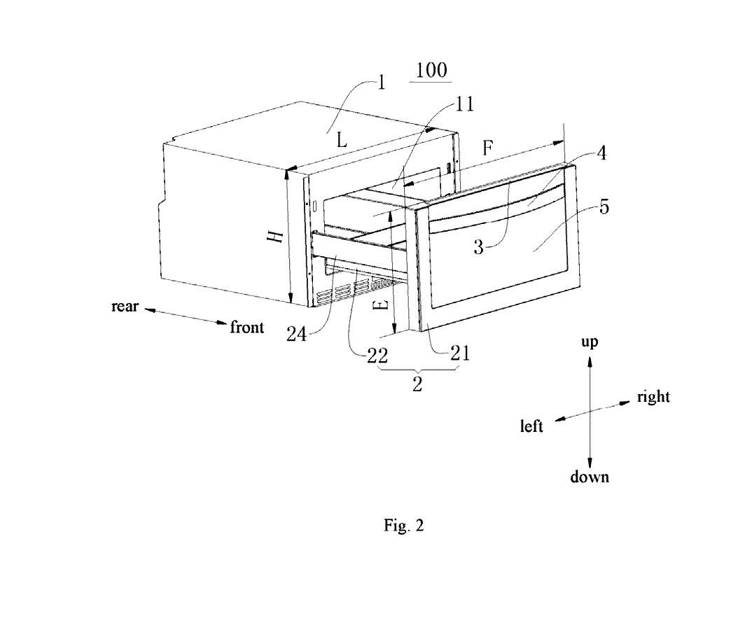

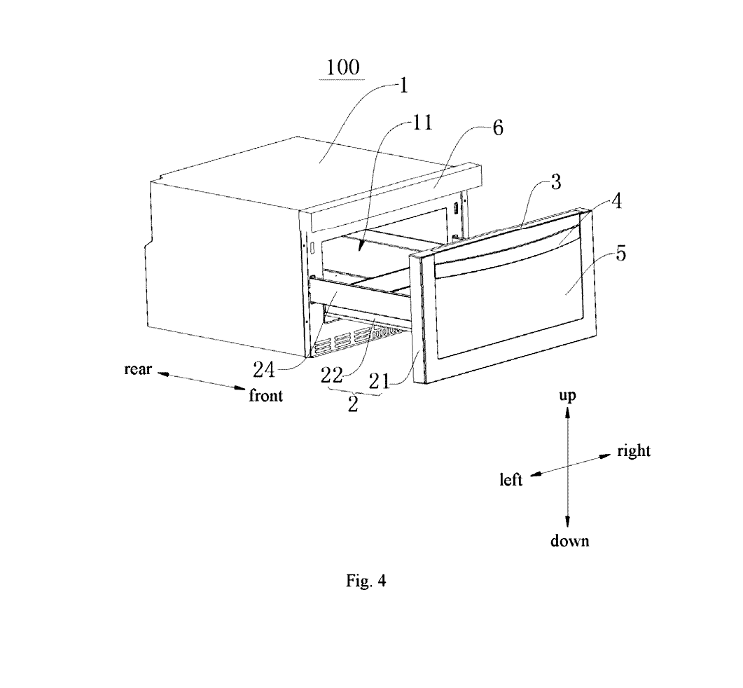

As shown in FIG. 2 and FIG. 4, the microwave heating device 100 according to embodiments of the present invention may include an oven body 1, a drawer door 2 and a control box.

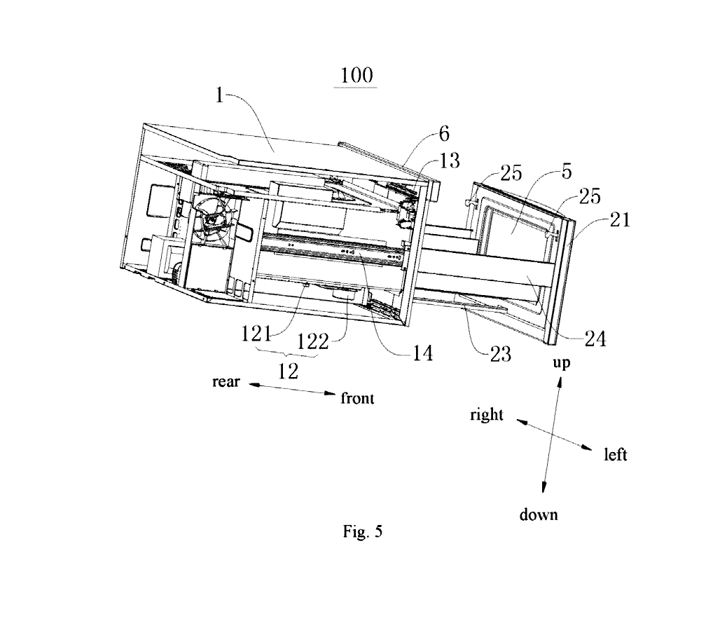

As shown in FIG. 2 and FIG. 4, the oven body 1 is defining a microwave heating chamber 11 therein, the drawer door 2 is movably installed on the oven body 1 so as to open and close the microwave heating chamber 11. In the example as shown in FIG. 5, both left and right sides of the drawer door 2 are provided with guide rail connecting plates 24, left and right side walls of the microwave heating chamber 11 are provided with guide rails 14, the guide rail connecting plates 24 cooperate with guide rails 14 so as to be movable in the oven body 1. As shown in FIG. 5, the oven body 1 is further provided with a driving device 12 which can include a push rod device 121 and an electric motor 122, the push rod device 121 is driven by the electric motor 122 and is connected with the drawer door 2 through a push rod 23, and the push rod device 121 can convert a rotational movement of the motor 122 to a linear movement of the push rod 23, thereby pushing and pulling the drawer door 2 to move and achieving opening and closing the drawer door 2.

The drawer door 2 is provided with a door panel 21, and the door panel 21 is provided with a hook 25 at a side thereof facing the oven body 1, the oven body 1 is provided with an interlocking bracket 13 therein, when the drawer door 2 is closed, the hook 25 fastens the interlocking bracket 13, so that the microwave heating device 100 starts to work.

The control box is provided with a control panel 3 through which the microwave heating device 100 can be operated, as shown in FIG. 2 and FIG. 4, the control box is installed at the top of the door panel 21, and the control panel 3 is facing upward, thus users can see the control panel 3 once lower their heads when they operate the control panel 3, thereby users do not need to bend over and stoop to operate, such that it is convenient to use for users, especially for those who cannot easily bend over or stoop, like elderly people, thus improving the convenience and the front aesthetics of the microwave heating device 100.

The microwave heating device 100 according to embodiments of the present invention enable users to see the control panel 3 once lower their heads when they operate the control panel 3 via making the control panel 3 facing upward, thereby users do not need to bend over or stoop to operate, such that it is convenient to use for users, especially for those who cannot easily bend over or stoop, like elderly people, thus improving the convenience and wide applicability of the microwave heating device 10, meanwhile as the control panel 3 is facing upward, thus improving the front aesthetics of the microwave heating device 100.

In some embodiments of the present invention, the door panel 21 may have an installing chamber therein and an operating port communicating with the installing chamber at an upper surface thereof, the control box is installed inside the installing chamber, the control panel 3 is arranged at the operating port and exposed from the operating port to facilitate users to operate. The control panel 3 communicates with the control box, and the microwave heating device 100 can be controlled via the control panel 3. Optionally, an upper surface of the control panel 3 is flush with the upper surface of the door panel 21, that is the upper surface of the control panel 3 and the upper surface of the door panel 21 are on the same plane, thus the control box can be hidden in the door panel 21 with only the control panel 3 being exposed, thereby making the door panel 21 more beautiful, and enabling the drawer door 2 to move conveniently when opening and closing the drawer door 2.

In some embodiments of the present invention, as shown in FIG. 2 and FIG. 4, the control panel 3 can be positioned at the central of the upper surface of the door panel 21 in a right-left direction, that is, a distance between the control panel 3 and a left side of the door panel 21 is the same with that between the control panel 3 and a right side of the door panel 21, and the control panel 3 is adjacent to a front surface of the door panel 21 in a front-rear direction. Thus, it is convenient for users to operate the control panel 3.

In some embodiments of the present invention, as shown in FIG. 1, the door panel 21 covers a whole front surface of the oven body 1 when closing the microwave heating chamber 11. Thus the door panel 21 fits with the oven body 1 so as to enable the microwave heating device to form a closed structure and to have a more neat and beautiful front appearance.

In specific, as shown in FIG. 2, a size of a rear surface of the door panel 21 in an up-down direction is E, a size of the door panel 21 at the rear surface in an left-right direction is F, a size of the oven body 1 at a front surface in an up-down direction is H, a size of the oven body 1 at a front surface in an left-right direction is L. the size E of the door panel 21 at the rear surface in the up-down direction is larger than the size H of the oven body 1 at the front surface in the up-down direction, and the size F of the door panel 21 at the rear surface in the left-right direction is larger than the size L of the oven body 1 at the front surface in the left-right direction, i.e. E>H, F>L. Thus the sizes of the door panel 21 both in the up-down direction and the left-right direction are larger than the sizes of the oven body 1 at the front surface, thus the door panel 21 can cover the entire front surface of the oven body 1 when closing the microwave heating chamber 11 and the door panel 21 can shield a gap between the oven body 1 and a wall or cabinet after microwave heating device 100 is embedded in the wall or cabinet.

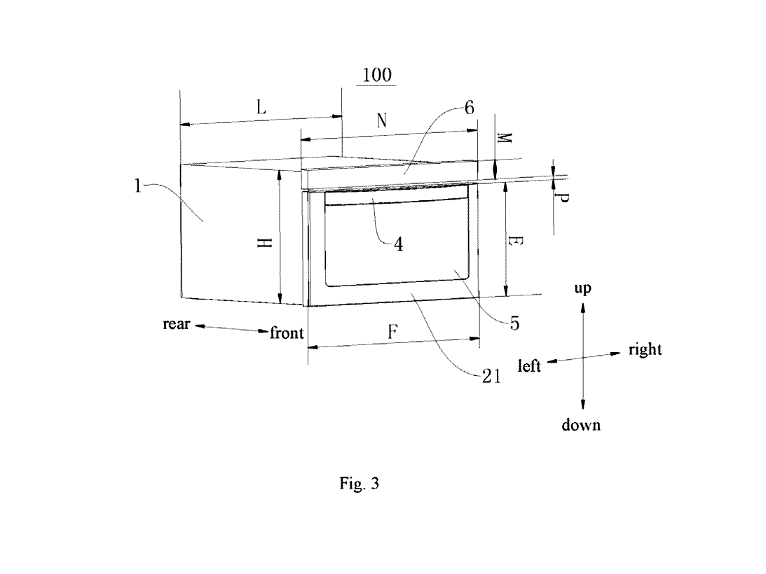

In other embodiments of the present invention, as shown in FIG. 3 to FIG. 5, the oven body 1 can be provided with a decorative piece 6, the control panel 3 is shielded by the decorative piece 6 when the door panel 21 closes the microwave heating chamber 11, the control panel 3 avoids the decorative piece 6 and is exposed when the door panel 21 opens the microwave heating chamber 11. As shown in FIG. 3 to FIG. 5, the decorative piece 6 is provided at the front surface of the oven body 1 and positioned at an upper part of the oven body 1, as shown in FIG. 3, when the door panel 21 is closed, the decorative piece 6 is positioned above the door panel 21, and can completely cover the control panel 3, as shown in FIG. 4 and FIG. 5, when the door panel 21 is opened, the control panel 3 moves along with the drawer door 2 away from the decorative pieces 6 to avoid being shielded. Thus the decorative pieces 6 can protect the control panel 3 from collision and damage, and improve the aesthetics of the microwave heating device 100.

Optionally, the decorative piece 6 can be provided at the front surface of the oven body 1 and extends in the left-right direction, the door panel 21 with the decorative piece 6 covers the whole front surface of the oven body 1 when the door panel 21 closes the microwave heating chamber 11. Combined with what is shown in FIG. 3 to FIG. 5, the decorative piece 6 is a roughly rectangular shape, and a longitudinal direction of the decorative piece 6 extends in the left-right direction, when the drawer door 2 is closed, the door panel 21 fitting with the decorative piece 6 can cover the whole front surface, and the decorative pieces 6 can protect the control panel 3 from damage at the same time.

Further, when the door panel 21 closes the microwave heating chamber 11, a left side surface of the door panel 21 is flush with a left side surface of the decorative piece 6, and a right side surface of the door panel 21 is flush with a right side surface of the decorative piece 6. That is, the size of the door panel 21 in the left-right direction is the same with that of the decorative piece 6 in the left-right direction, thus enabling the structure of the microwave heating device 100 more reasonable and compact, and improving the aesthetics of the microwave heating device 100.

In other embodiments of the present invention, both the decorative piece 6 and the door panel 21 have larger sizes at the rear surfaces in the left-right direction than the size at the front surface of the oven body 1 in the left-right direction, a sum of sizes at the rear surfaces of the decorative piece 6 and the door panel 21 in the up-down direction adding a gap between the decorative piece 6 and the door panel 21 is larger than the size at the front surface of the oven body 1 in the up-down direction. As shown in FIG. 4, the size of the decorative piece 6 at the rear surfaces in the left-right direction is N, the size of the decorative piece 6 at the rear surfaces in the up-down direction is M, the size of the door panel 21 at the rear surfaces in the left-right direction is F, the size of the door panel 21 at the rear surfaces in the up-down direction is E, the size of the oven body 1 at the front surfaces in the left-right direction is L, the size of the oven body 1 at the front surfaces in the up-down direction is H, the gap between the decorative piece 6 and the door panel 21 in the up-down direction is P, wherein N=F>L, E+M+P>H. Thus the decorative piece 6 fitting with the door panel 21 can cover the whole front surface of the oven body 1, and the door panel 21 and the decorative piece 6 can shielded the gap between the oven body 1 and the wall or cabinet after the microwave heating device 100 is embedded in the wall or cabinet.

In an embodiment of the present invention, the door panel 21 can be provided with a window 5 for observing a situation inside the microwave heating chamber 11, as shown in FIG. 1 to FIG. 5, the window 5 is provided on the front surface of the door panel 21, The heating situation of the food inside the microwave heating chamber 11 can be observed through the window 5, user can operate the microwave heating device 100 based on what they observed through the window 5, thus facilitating user to observe and manipulate.

In an embodiment of the present invention, the door panel 21 can be provided with a door handle 4 for pushing and pulling the drawer door 2. As shown in FIG. 1 to FIG. 4, the door handle 4 can be provided on the front surface of the door panel 21 so as to manually achieve the opening and closing of the drawer door 2 through pushing and pulling the drawer door 2 via the door handle 4.

Other components and operations of the microwave heating device 100 according to the present invention are known to those ordinary skilled in the related art, and will not be described in detail here.

In addition, the present invention further provided a drawer door assembly used for the microwave heating device.

The drawer door assembly used for the microwave heating device according to embodiments of the present invention may include a drawer 22, a door panel 21 and a control box.

The door panel 21 is installed on the drawer 22, the food to be heated can be placed inside the drawer 22. The control box is provided with a control panel 3 and installed at the top of the door panel 21, and the door panel 3 on the control box is facing upward. Thus the users do not need to bend over or stoop to operate, thereby it is convenient to use for elderly people, thereby improving the use of convenience and the overall aesthetics of the microwave heating device.

The drawer door assembly used for the microwave heating device according to embodiments of the present invention enable the user to see the control panel 3 once lower their heads when they operate the control panel 3 via making the control panel 3 facing upward, thereby users do not need to bend over or stoop to operate, such that it is convenient to use for users, especially for those who cannot easily bend over or stoop, like elderly people, thus improving the convenience and wide applicability of the microwave heating device, and improving the aesthetics of the microwave heating device at the same time.

In the present invention, unless specified or limited otherwise, a structure in which a first feature is “on” or “below” a second feature may include an embodiment in which the first feature is in direct contact with the second feature, and may also include an embodiment in which the first feature and the second feature are not in direct contact with each other, but are contacted via an additional feature formed therebetween. Furthermore, a first feature “on,” “above,” or “on top of” a second feature may include an embodiment in which the first feature is right or obliquely “on,” “above,” or “on top of” the second feature, or just means that the first feature is at a height higher than that of the second feature; while a first feature “below,” “under,” or “on bottom of” a second feature may include an embodiment in which the first feature is right or obliquely “below,” “under,” or “on bottom of” the second feature, or just means that the first feature is at a height lower than that of the second feature.

In the description of the present invention, it should be understood that, unless specified or limited otherwise, the terms “mounted,” “connected,” “coupled,” and the like are used broadly, and may be, for example, fixed connections, detachable connections, or integral connections; may also be mechanical or electrical connections; may also be direct connections or indirect connections via intervening structures; may also be inner communications of two elements, which can be understood by those skilled in the art according to specific situations.

Reference throughout this specification to “an embodiment,” “some embodiments,” “one embodiment”, “another example,” “an example,” “a specific example,” or “some examples,” means that a particular feature, structure, material, or characteristic described in connection with the embodiment or example is included in at least one embodiment or example of the present invention. Thus, the appearances of the phrases such as “in some embodiments,” “in one embodiment”, “in an embodiment”, “in another example,” “in an example,” “in a specific example,” or “in some examples,” in various places throughout this specification are not necessarily referring to the same embodiment or example of the present invention. Furthermore, the particular features, structures, materials, or characteristics may be combined in any suitable manner in one or more embodiments or examples.

Although explanatory embodiments have been shown and described, it would be appreciated by those skilled in the art that the above embodiments cannot be construed to limit the present invention, and changes, alternatives, and modifications can be made in the embodiments without departing from spirit, principles and scope of the present invention.

What is claimed is:

1. A microwave heating device, comprising:
an oven body defining a microwave heating chamber therein;
a drawer door provided with a door panel and movably installed on the oven body so as to enable the door panel to open and close the microwave heating chamber;
a control box having a control panel and installed at the top of the door panel, and the control panel being facing upward.

2. The microwave heating device according to claim 1, wherein the door panel defines an installing chamber therein and an operating port communicated with the installing chamber at an upper surface thereof, the control box is installed inside the installing chamber, and the control panel is exposed from the operating port.

3. The microwave heating device according to claim 2, wherein an upper surface of the control panel is flush with the upper surface of the door panel.

4. The microwave heating device according to claim 2, wherein the control panel is positioned at the central of the upper surface of the door panel in a right-left direction, and is adjacent to a front surface of the door panel in a front-rear direction.

5. The microwave heating device according to claim 1, wherein the door panel covers a whole front surface of the oven body when closing the microwave heating chamber.

6. The microwave heating device according to claim 5, wherein the door panel has a larger size at a rear surface in an up-down direction than a size at the front surface of the oven body in the up-down direction, and the door panel has a larger size at the rear surface in an left-right direction than a size at the front surface of the oven body in the left-right direction.

7. The microwave heating device according to claim 1, wherein the oven body is provided with a decorative piece, the control panel is shielded by the decorative piece when the door panel closes the microwave heating chamber, the control panel avoids the decorative piece and is exposed when the door panel opens the microwave heating chamber.

8. The microwave heating device according to claim 7, wherein the decorative piece is provided at the front surface of the oven body and extends in the left-right direction, the door panel with the decorative piece covers the whole front surface of the oven body when the door panel closes the microwave heating chamber.

9. The microwave heating device according to claim 8, wherein when the door panel closes the microwave heating chamber, a left side surface of the door panel is flush with a left side surface of the decorative piece, and a right side surface of the door panel is flush with a right side surface of the decorative piece.

10. The microwave heating device according to claim 9, wherein both the decorative piece and the door panel have larger sizes at the rear surfaces in the left-right direction than the size at the front surface of the oven body in the left-right direction, a sum of sizes at the rear surfaces of the decorative piece and the door panel in the up-down direction adding a gap between the decorative piece and the door panel is larger than the size at the front surface of the oven body in the up-down direction.

11. The microwave heating device according to claim 1, wherein the door panel is provided with a window for observing a situation inside the microwave heating chamber.

12. The microwave heating device according to claim 1, wherein the door panel is provided with a door handle for pushing and pulling the drawer door.

13. A drawer door assembly used for the microwave heating device, comprising:
a drawer;
a door panel installed on the drawer;
a control box having a control panel and installed at the top of the door panel, and the control panel being facing upward.
